(19) United States
(12) Patent Application Publication
(10) Pub. No.: US 2015/0237949 A1
(43) Pub. Date: Aug. 27, 2015

(54) SAFETY BOOTS WITH MULTI LEVEL SAFETY FEATURES

(71) Applicant: Efthimios Poulos, Toronto (CA)

(72) Inventor: Efthimios Poulos, Toronto (CA)

(21) Appl. No.: 14/188,803

(22) Filed: Feb. 25, 2014

(51) Int. Cl. A43B 3/00; A43B 3/02; B60Q 9/00

(52) U.S. Cl. CPC A43B 3/001; B60Q 9/008; A43B 3/02

(57) ABSTRACT

The present invention is a safety boot having LED warning lights for use in low visibility environments, wherein the LED lights having a particular light flashing pattern and high light intensity to be seen in hazardous environments, such as subway tunnels, mine shafts and in other low visibility conditions, and further having a sender/receiver warning signal to warn an approaching vehicle or machine.

### FIELD OF THE INVENTION

The present invention relates to a safety boot having LED warning lights and a sender and receiver warning signal embodied in the heels, sole and the body of the safety boot.

### BACKGROUND OF THE INVENTION

Maintaining safety at workplace is the concern of all organizations. Whether it is a hazardous occupation or a normal office job, a company must be dedicated towards implementing stringent safety standards. Workplaces such as mining and construction involve life threatening risks. Therefore specific guidelines must be set for ensuring safety of workers. Safety measures and standards are determined by the company prior to recruiting employees for eliminating any inconvenience that might be caused at the workplace. One such safety measure, is the requirement for wearing safety boots at potentially unsafe conditions and work places. The safety boots are designed to protect one's feet in case of falling objects or other impacts. Most workers working in unsafe conditions also wear reflective outfits to make themselves visible to others. Current safety boots do not provide proper safety measures in underground and tunnel operations, where there is no light or poor lighting, or at night construction, where outdoor lighting is limited.

The prior art provides a number of safety boots and shoes with flashing lights. The prior art lighted footwear have the same basic components, namely, at least one light source, a power source and a switch. U.S. Pat. No. 5,500,635 issued to Jonathan C. Mott, discloses a shoe incorporating an impact sensing element made from polymeric piezoelectric material. In response to impact, the piezoelectric material generates an electrical signal to a battery-powered light thus causing circuitry to energize the light device from the battery. U.S. Pat. No. 5,577,828 issued to Craig P. Nadel, discloses a shoe that defines a curved mounting surface which includes a decorative, illuminable assembly affixed over the mounting surface. The shoe has a cavity, which is dimensioned and arranged to receive at least one light emitting element. U.S. Pat. No. 5,604,999 issued to Dale E. Barker discloses a footwear with illuminated liner optics. Illuminated footwear having a power source, at least one light source operatively connected to the power source, a switching circuit for selectively illuminating the light source, and a linear side-glow optical conduit positioned exteriorly on the footwear so as to be visible when illuminated. U.S. Pat. No. 5,746,499 issued to Ratcliffe et al. disclosed a footwear with pulsed light that can be disposed in the sole of a shoe. The device includes a circuit having a switch responsive to pressure from the wearer's foot that activates a lighting circuit for a predetermined period of time or until the switch is operated again. The lighting circuit produces a pulsed light visible exteriorly of the sole of the shoe. The circuit can be controlled to operate either when the wearer's foot is brought into contact with, or when it is removed from, the ground.

A need exists for a new safety boot that achieves all of the objectives of conventional safety boots and to provide safe working environment in low visibility conditions.

### SUMMARY OF THE INVENTION

The present invention relates to a footwear, in particular it relates to an advanced protective boot, which incorporates a plurality of special programmable LED lights. The LED lights can provide a particular light pattern and intensity to be seen in hazardous environments, such as in subway tunnels, mine shafts and other bad air and weather conditions. The present boot may also be equipped with a sender and receiver warning signal for communication between the safety boot and a device in a working environment. The present safety boot also having a power source, such as a rechargeable battery or other electrical power supply means, and all of the appropriate circuitry necessary for illuminating the lights means. The safety boot further having a switching circuit for selectively illuminating the lights means, when an on/off switch is activated. The present safety boot further having interchangeable light filter members, positioned in front of the light sources to change the color and brightness of the light.

In another embodiment of the same safety boot, a communication device that acts as a sender and a receiver being embodied inside the safety boot and communicates with another device or machine. The communication device provides a warning to the user of the safety boot that another device or machine is approaching, and a warning to the other device and machine that a safety boot user is close by. The other device or machine can be a train, a crane, a forklift, a truck or any other machine in motion. The warning signal can be a beeping sound that the safety boot makes, a change in the color of the LED lights in the safety boots, a change in the intensity of the LED lights or a vibration in the safety boots to inform the user that a machine or vehicle is approaching. Similarly, the driver of the vehicle or the machine operator may be informed by the warning means inside the cabin of the vehicle that a worker is close by.

In one embodiment of the present invention, a battery management system and a communication means being housed in a cavity located in the heel of a boot and a light means being housed on the exterior of the heel in suitable openings formed on the heel of the boot.

It is the first objective of the present invention to provide a safety boot that incorporates plurality of programmable LED lights which can provide various light patterns for high worker safety. The user can change the light patterns based on their working environment.

It is the second objective of the present invention to provide a communication means between a boot and a vehicle to notify the wearer of the boot which worn the boot that said device is getting close to him/her.

It is the third objective of the present invention to provide multi-level safety features for workers in a working environment. The safety features are working parallel to each other to build a safer working place.

It is the fourth objective of the present invention to provide a rechargeable battery to recharge the battery management system to save various amount of energy to illuminate the LED lights and a communication means.

This recharging capability can be accomplished in different methods such as by using a battery recharging adaptor having a recharger plug located on the heel portion of the safety boot such as the recharger receptacle, or using docking station to recharge the batteries. The receptacles in this case can be located on the sole portion of the boot. The boots can be easily recharged at an appropriate docking station whenever needed.

Other objects, features and advantages of the present invention will be readily appreciated from the following description. The description makes reference to the accompanying drawings, which are provided for illustration of the preferred embodiment. However, such embodiment does not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a side view of the first embodiment of the present invention wherein a safety boot incorporates plurality of LED lights embodied on the heel and the body of a safety boot with an ON/OFF button on the tongue of the boot;

FIG. 2 shows another side view of the first embodiment of the present invention with a selector button on the tongue of the boot;

FIG. 3 shows a back view of the first embodiment of the present invention;

FIG. 4 shows a schematic view of communication system between a boot and a vehicle;

FIG. 5 shows a schematic diagram of the functionality of a safety boot;

FIG. 6 shows a bottom view of the present invention;

FIG. 7 shows another embodiment of the safety boot which is placed on a docking station for recharging boot's battery; and

FIG. 8 shows another embodiment of a safety boot of the present invention wherein recharging wires are embodied in the shoe laces of said boot, wherein one end of said laces being used to plug into a recharging station.

### DETAILED DESCRIPTION OF THE DRAWINGS

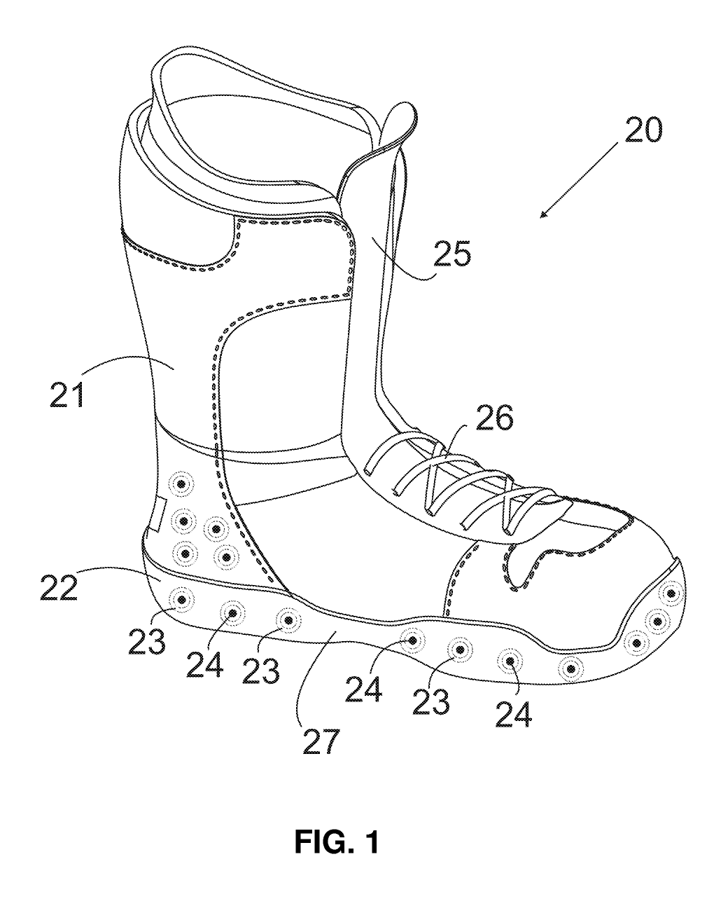

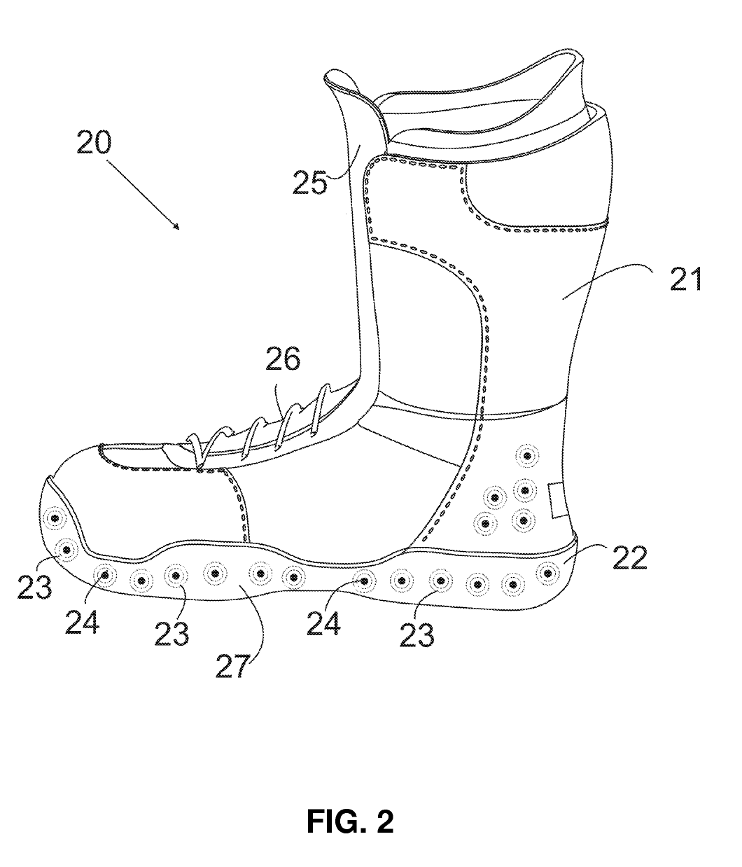

FIGS. 1-3 show a safety boot 20 having an exemplary embodiment of the present invention. The safety boot 20 comprises of a body 21, a heel 22, a boot tongue 25, and a lace 26. Said heel 22 having a plurality of cavities 23 to receive LED lights 24.

LED lights 24 used in the present invention are designed so that they are visible from long distances in dark places such as tunnels and mines. Combination of colors in high intensity flash lights and different flash rates may provide maximum visibility and create a highly visible warning and safety zone.

For security purposes, LED lights 24 are selected from the group of LED lights that are gas proof and water proof. Gas proof feature provides a safety boot that may be used in places having a flammable gas.

Referring to FIGS. 1-3, LED lights 24 are embodied on the heel 22 of the safety boots 20. Therefore, the boot is clearly visible from the front and the back.

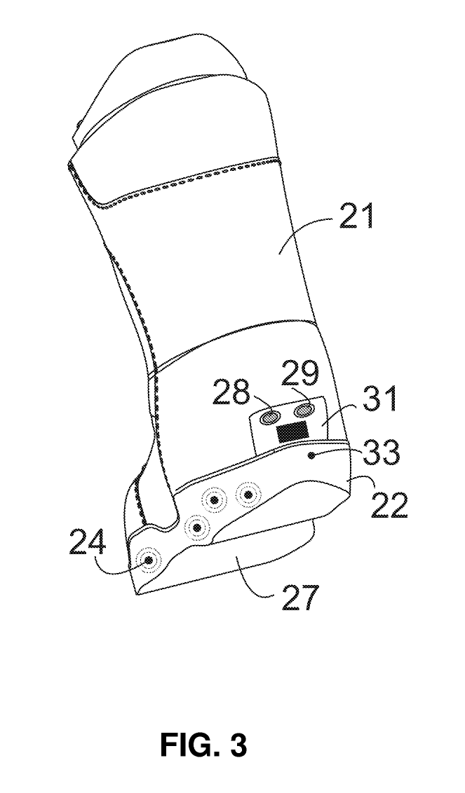

As shown in FIG. 3, for safety purposes, the boots 20 are equipped with a communication means 31, which can communicate with a vehicle in a specific distance. The intention of the present invention is to integrate different safety means to help users in preventing unexpected accidents. A warning light 33 is designed to warn the wearer that the battery power is low.

Again referring to FIG. 3, an ON/OFF button 28 is installed in the upper part of the heel of the boot 22 to manage and turn the LED lights 24 ON and OFF. It is understood that the ON/OFF button can be located at any other operationally feasible locations on the boot.

Again referring to FIG. 3, a selector button 29 is designed in the upper part of the heel of the boot 22 to manage the illumination option for the LED lights 24. One of the embodiments of the selector button 29 selects from high, medium, and low options for the brightness of the LED lights 24. The user can select the brightness of the LED lights 24 based on a working environment. The location of the selector button 29 on the boot heel 22 is accessible at any time for the user.

One of the embodiments of the selector button 29 selects different light patterns from predefined programmed light patterns. The user in different working environment can easily select different light pattern based on the working environment and weather condition. These light patterns are selected from the light patterns that draw more attention for the objects found in the environment and can also penetrate through longer distances in the working environment. It is understood that a multi-functional button can be used to provide all the functions that are separately provided by buttons 28 and 29.

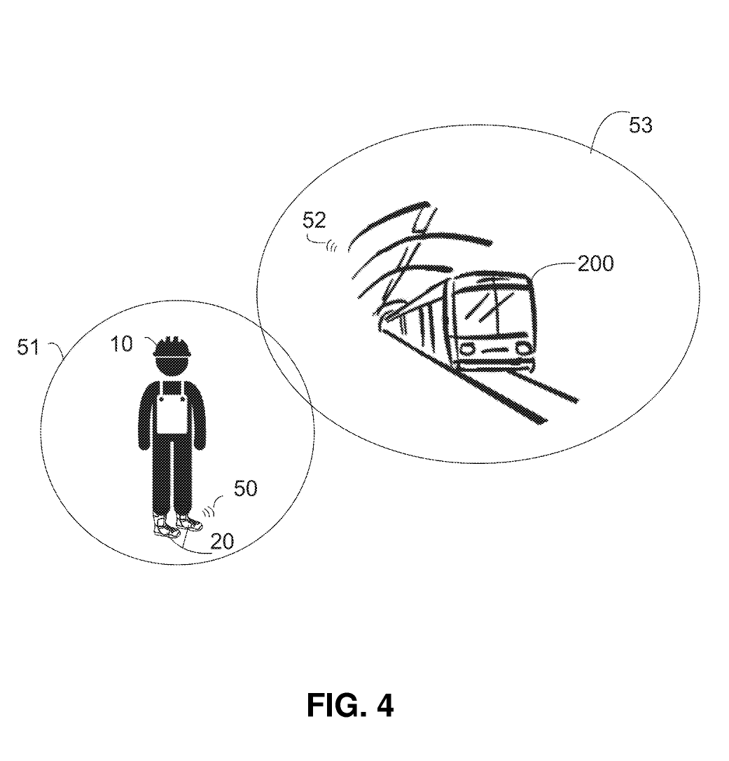

As shown in FIG. 4, a boot 20 which is worn by a user 100, has a communication means 50 to send and receive a warning signal in a boot warning zone 51. A vehicle 200 has a same communication means 52 which sends and receive a warning signal in a vehicle warning zone 53.

Again referring to FIG. 4, the warning zones 51, 53 are in a 3D space, when warning zones 51, 53 connect in a 3D space, they can communicate with each other and send and receive a warning signal which inform both of them the existence of each party in its warning zone. The warning zone of the boot and the vehicle can be adjusted.

In one embodiment of the present invention, when boot 20 or vehicle 200 are located in a warning zone 51, 53, a warning signal received to the boot 20, said boot 20 can change the illumination patterns and inform the user that a vehicle is in the warning zone 51. The receiver on the vehicle 200 received a warning signal, by such a reception; the driver of a vehicle 200 notified by a warning light at front of the vehicle that someone is in the vehicle warning zone 53.

The communication between the boot and the vehicle can be selected from variety of communication means such as Wi-Fi communication, Bluetooth or stationary communication.

The boots 20 can respond to the receiving signal by changing the light pattern, changing the flashing pattern, changing the colors of the LED lights or making a warning sound to notify a user that a vehicle is in its warning zone.

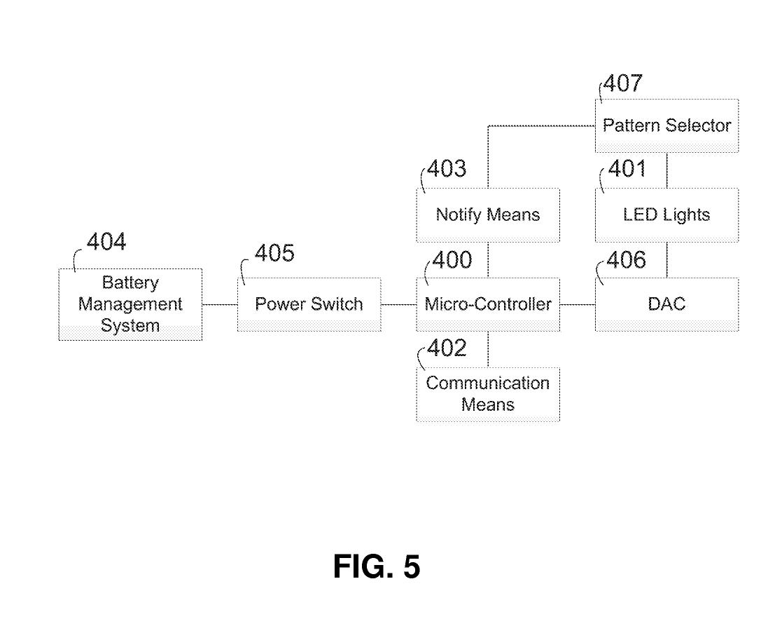

To handle these safety features as shown in FIG. 5, the safety boots comprising of a plurality of LED lights 401, a communication means 402, a notifier means 403, a battery management system 404 and an electrical circuit board with a micro-controller 400 to manage the safety task and the communication between a boot and a vehicle. A power switch 405, turns ON and OFF the safety operations of the boot and the vehicle. A DAC 406 (digital to analog convertor) function that converts digital data to analog data and commend to LED lights 401 to illuminate in a different pattern by help of pattern selector 407.

In one embodiment of the present invention, the user which worn a boot can select different light patters in different situation. Based on his/her selection, the light pattern can be changed during a work time or in a warning time. In this case, the user can select a specific light pattern based on the work place and weather conditions.

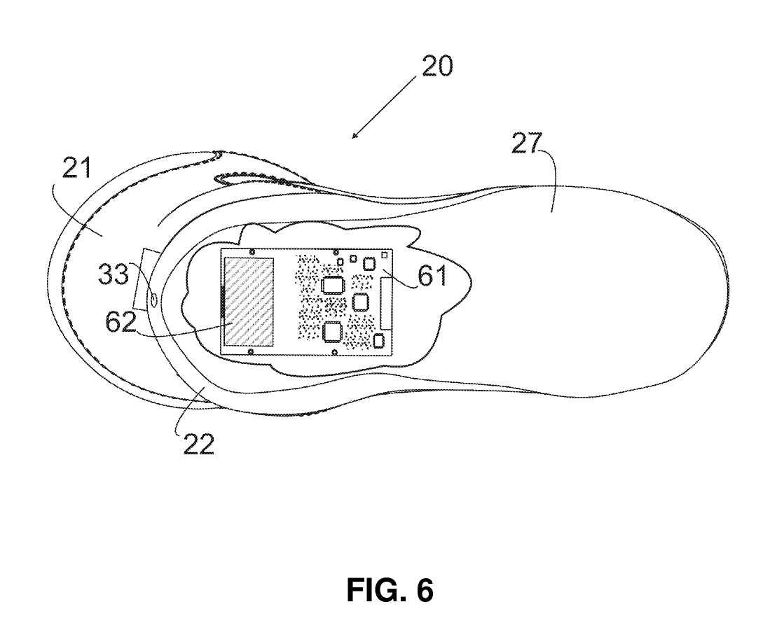

The electronic circuit 61 and the rechargeable battery 62 are located in a sole 27 of the safety boots 20 as shown in FIG. 6. The thickness of the heel 22 and the sole 27 of the safety boots 20 is enough to size an electronic circuit 61 and a battery 62 inside. The material of the sole are selected from the group of plastics that insulate the electronic circuit 61 and the battery 62.

As shown in FIG. 6, a micro-controller can be embodied in said electronic circuit 61 to control the color changing, intensity, light flashing and other desired modes of the LED lights by using a pattern selector that is embodied in said electronic circuit 61. As shown in the FIG. 6, all necessary elements are designed in said electronic circuit 61 such as communication means and notifier means.

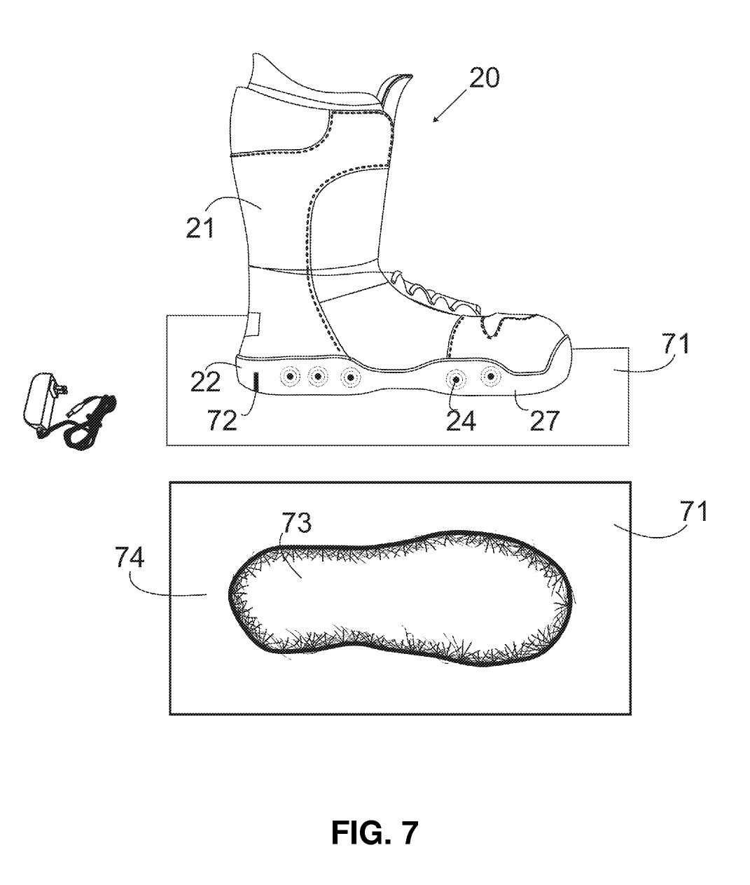

In one embodiment of the present invention as shown in FIG. 7, the safety boot 20 can be positioned on a docking station 71 to charge the battery. The user can charge the boot 20 when he/she is not working by simply placing it on the docking station 71 to prepare it for the next operating time. The battery is designed to manage necessary power for communication means and LED lights during a working time. The docking station has a hole 73 sized to fit the safety boots 20, at the edge of the hole 73, there is plurality of comb-like protrusions 74 that clean the sole 27 and the heel 22 of the safety boots 20. In this specific embodiment of the present invention, the docking station 71 is connected to the safety boots 20 with a sock 72 at the bottom of the heel 22.

Inductive charging mat is used for charging electronic devices such as cell phones and laptops, in another embodiment of the present invention as shown in FIG. 7, a mat 71 can be an inductive charging mat to transfer energy between the mat 71 and the battery inside the boots 20. In this way, by putting boots 20 on top of the mat 71, the battery can be charged.

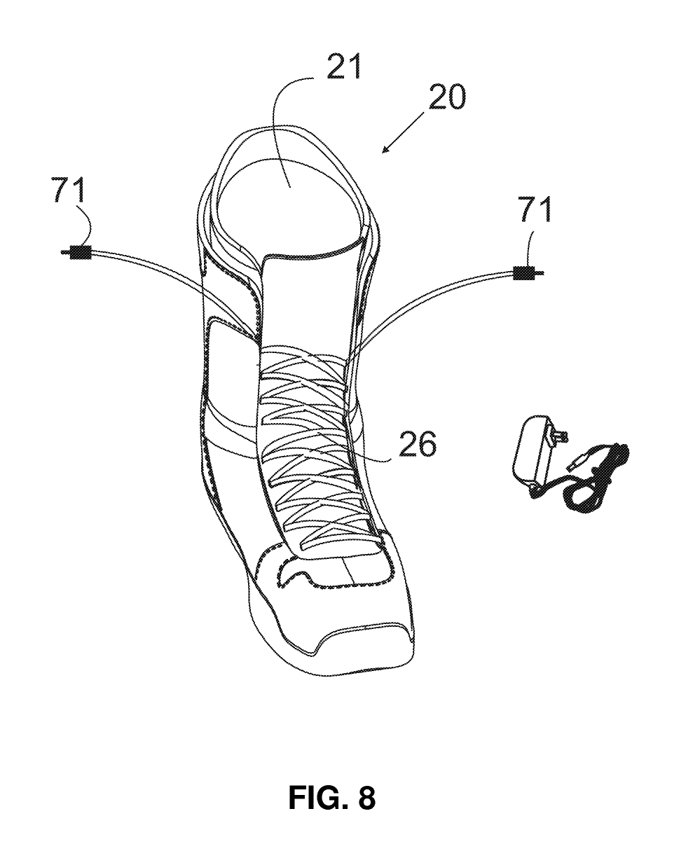

In another embodiment of the present invention as shown in FIG. 8, the boot laces 81 of said safety boot 20 are designed to be used as a wire with a battery socket that is connected to the battery and power source to charge the battery. For safety reasons the lace 81 can be embodied in the body 21 of the safety boots 20 and used when it is needed for charging a battery.

In another embodiment of the present invention, the communication means can be located in any safety devices such as a safety jacket, trousers, safety gloves and a helmet.

In another embodiment of the present invention, the safety features can be presented at combat boots, cowboy boots, fashion boots, hiking boots, motorcycle boots, athletic shoes, fashion shoes and any kind of footwear.

The forgoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A footwear having multi-level warning system, said footwear comprising:
a. a heel, a heel counter, a sole having a thickness, a tongue having a free end, and a pair of laces;
b. said heel having a cavity shaped and sized to receive an electronic box;
c. a plurality of high intensity LED warning lights installed on said footwear;
d. said electronic box having controlling means to control the operation of said LED lights;
e. said controlling means controlling the intensity and flashing pattern of said LED lights;
f. said footwear further having a battery management system to supply power to said LED lights;
g. a power switch means to turn on and off said footwear, and
h. a pattern selector means to select the flashing pattern of said LED lights.

2. The footwear of claim 1, wherein said LED lights being installed on said heel.

3. The footwear of claim 1, wherein said LED lights being installed on said heel counter.

4. The footwear of claim 1, wherein said LED lights being installed on said sole.

5. The footwear of claim 1, wherein said power switch means being installed on said heel counter.

6. The footwear of claim 1, wherein said pattern selector means being installed on said heel counter.

7. The footwear of claim 1, further having a micro-controller to control the intensity and pattern of said LED lights.

8. The footwear of claim 1, further having a warning means to alert the wearer of the footwear of an approaching vehicle or machine.

9. The footwear of claim 8, wherein said warning means comprising: a first communication means to allow the boot to communicate with a second communication means installed on a moving vehicle or machine; and a warning signal, whereby said communication being carried within a predefined warning zone.

10. The footwear of claim 9, wherein said first and said second communication means being selected from a group of Wi-Fi, Bluetooth, and radio frequency communication devices.

11. The footwear of claim 9, wherein said warning zone being a 3D space around said footwear being define by the operational range of said communication means.

12. The footwear of claim 8, wherein said warning means being selected from a group of changing in the light pattern of said LED lights, changing in flash patterns of said LED lights, changing in intensity of said LED lights, and changing in a color of said LED lights.

13. The footwear of claim 9, wherein said warning signal being a change in LED light intensity, color, or flashing rate, or a warning sound, or a vibration induced in the footwear.

14. The footwear of claim 1, wherein said footwear being a safety boot, a combat boot, an athletic shoe, a fashion shoe, and a children's shoe.

15. A warning device to notify a user of an approaching vehicle, said device comprising: a wearable warning signal sender/receiver means to be worn by a user; a vehicle warning signal sender/receiver means being installed in a vehicle, and wherein said wearable and vehicle warning means being activated generating a warning signal once they are within a predefined distance from each other.

16. The warning device of claim 14, wherein said wearable warning means being a safety boot.

17. The warning device of claim 14, wherein said signal sender/receiver means being one of Wi-Fi, Bluetooth, radio frequency, or other similar communication devices.

18. The warning device of claim 14, wherein said warning signal being any one of flashing LED lights installed, sound or vibration.
